(19) United States
(12) Patent Application Publication
(10) Pub. No.: US 2025/0288948 A1
(43) Pub. Date: Sep. 18, 2025

(54) Performance-Enhanced Sulfur Scavenging Compositions

(71) Applicant: Jason Martin THOMPSON, San Angelo, TX (US)

(72) Inventor: Jason Martin THOMPSON, San Angelo, TX (US)

(21) Appl. No.: 19/082,744

(22) Filed: Mar. 18, 2025

Related U.S. Application Data
(60) Provisional application No. 63/566,506, filed on Mar. 18, 2024.

(51) Int. Cl. B01D 53/14; C10K 1/00

(52) U.S. Cl. CPC B01D 53/1493; B01D 53/1468; C10K 1/004; B01D 2252/20436; B01D 2252/20484; B01D 2252/20489; B01D 2252/504; B01D 2257/304; B01D 2257/306

(57) ABSTRACT

This invention pertains to performance-enhanced compositions for scavenging sulfhydryl moieties from hydrocarbon streams, especially gas streams, and processes for the use of such compositions.

### CROSS-REFERENCE TO A RELATED APPLICATION

This application claims priority to U.S. Provisional Patent Application Ser. No. 63/566,506, filed Mar. 18, 2024; which is incorporated by reference herein in its entirety.

### FIELD OF THE INVENTION

This invention pertains to performance-enhanced compositions for scavenging sulfhydryl moieties from hydrocarbon streams, especially gas streams, and processes for the use of such compositions.

### BACKGROUND OF THE INVENTION

The removal of hydrogen sulfide from hydrocarbon streams, especially gas streams, is often required in order to meet many pipeline and storage regulations. Hydrogen sulfide and mercaptans are toxic and have an offensive odor, and these components can be adverse to downstream process equipment. Even in situations where the gas stream is flared, the presence of hydrogen sulfide and mercaptans result in the generation of pollutants such as sulfur dioxide and removal of these sulfur compounds may be mandated.

Numerous processes have been proposed for the removal of hydrogen sulfide and mercaptans including adsorption, absorption and reactions with chemical agents. Since it is desired to remove hydrogen sulfide and mercaptans at the source of hydrocarbon stream in order to permit pipeline transport and storage of flaring, the processes need to be able to be operated under the conditions of the environment at the source. Often, the sources are remotely located and may be subject to harsh environments such as would be the case with natural gas wells. Because of such remote locations, minimization of operating problems is particularly desirable.

One type of process for removal of hydrogen sulfide uses hydrogen sulfide scavengers that react with sulfhydryl moieties to provide a compound which can be removed from the hydrocarbon.

Improvements are sought for processes to remove sulfhydryl moieties using hydrogen sulfide scavengers, especially processes that increase up-take of sulfhydryl moieties and are economically attractive for commercial hydrocarbon treatment operations.

### BRIEF SUMMARY OF THE INVENTION

By this invention, processes and compositions for scavenging sulfhydryls are provided that increase the up-take of sulfhydryl moieties from hydrocarbon streams. The increased up-take can be in one or both of the rate of up-take and the amount of sulfhydryl scavenged prior to the scavenger being spent.

The processes and compositions of this invention are operable in, for example, existing scrubbing systems and for continuous injection in a production train for the removal of hydrogen sulfide from hydrocarbon streams, and are operable in the presence of water.

In accordance with this invention, it has been found that providing a water-dispersible, metal-containing, dielectric component in an aqueous sulfur scavenger composition increases the up-take of the sulfur scavenger. While not wishing to be limited by theory, it is believed that the dielectric component interacts with the sulfur scavenger, that is, the component in the composition that removes, by reaction or association, the sulfhydryl moiety from a hydrocarbon stream containing the sulfhydryl moiety. This interaction serves, in part, to stabilize the forces attracting a sulfhydryl moiety to the sulfur scavenger. It is believed that an electrical field exists around the sulfur scavenger due to polar positive and/or polar negative sites on the sulfur scavenger and this electrical field influences the rate of transport of the sulfhydryl moieties to the scavenger sites. This electrical field can be affected by other components in the composition. The dielectric component can also attenuate changes due to the sulfhydryl moiety reacting or associating with sites on the sulfur scavenger.

In certain embodiments, the compositions of this invention comprise an amine-based sulfur scavenger; water; and a water dispersible, metal-containing, dielectric component.

The sulfur scavenger preferably is an amine-based scavenger containing at least one of a primary, secondary or tertiary nitrogen. In preferred embodiments, the sulfur scavenger comprises a triazine scavenger.

In some embodiments, the dielectric component is provided in an effective amount to increase the up-take of the sulfur scavenger, all other conditions being substantially the same, and is frequently in a mass ratio (on an anhydrous basis) to sulfur scavenger between about, e.g., 0.01:1000 to 50:1000, or 0.05:1000 to 20:1000.

In a preferred embodiment of the invention, the sulfur scavenger compositions comprise a sulfur scavenger; water; a water-dispersible, metal-containing, dielectric component; and a hydrocarbyl alcohol having a terminal hydroxy group, wherein the hydrocarbyl alcohol comprises about 8 to 24 carbons, at least one of which is a tertiary carbon. Without wishing to be limited by theory, it is believed that the hydrocarbyl alcohol facilitates transport of the sulfhydryl moiety to the scavenger. In this respect, the hydrocarbyl alcohol which has little, if any, solubility in water, migrates to the interface between the organic (sulfhydryl moiety-containing phase) and the aqueous, sulfur scavenger composition. The more organic interface provided by the hydrocarbyl alcohol facilitates migration of the sulfhydryl moiety into the aqueous scavenger composition where the sulfhydryl moiety can associate with the hydrocarbyl alcohol. The hydrocarbyl alcohol having a hydroxyl group and weak hydrogen to carbon covalent bonds, especially those on a tertiary carbon, is preferentially drawn to the amine-based scavenger due to the electrical forces of the scavenger. In certain embodiments, the hydrocarbyl alcohol is provided in a mass ratio to the scavenger of between about, e.g., 10:1000 to 400:1000, or 50:1000 to 250:1000.

In certain embodiments, the subject invention also pertains to an additive composition to be used with an aqueous, amine-based sulfur scavenger, which additive composition comprises a water-dispersible, metal-containing, dielectric component and a hydrocarbyl alcohol having a terminal hydroxy group, wherein the hydrocarbyl alcohol comprises about 8 to 24 carbons, at least one of which is a tertiary carbon. In certain embodiments, the mass ratio (on an anhydrous basis) of dielectric component to hydrocarbyl alcohol in the additive is between about, e.g., 0.5:100 to 50:100, or 1:100 to 40:100. The additive composition can be added to the aqueous, amine-based sulfur scavenger in an amount sufficient to enhance the up-take of sulfhydryl moiety by the scavenger.

In certain embodiments, the subject invention further provides methods for reducing an amount of sulfhydryl moieties in a hydrocarbon stream, which methods comprise contacting, generally in the presence of water, the hydrocarbon stream with a sulfur scavenger composition comprising at least one amine-based sulfur scavenger and a sulfhydryl scavenger performance-enhancing additive, wherein the additive comprises a water-dispersible, metal-containing, dielectric component.

In preferred embodiments, the method further comprises applying a hydrocarbyl alcohol to the hydrocarbon stream, wherein the hydrocarbyl alcohol comprises a terminal hydroxy group and about 8 to 24 carbons, at least one of which is a tertiary carbon.

Advantageously, the subject invention can improve the production of oil and natural gas by, for example, reducing equipment corrosion, improving the quality of produced oil and gas, and reducing the operational and environmental hazards caused by sulfhydryl compounds.

### BRIEF DESCRIPTION OF THE DRAWINGS

FIG. 1 is a depiction of the test setup used to evaluate sulfur loading and reaction kinetics.

FIG. 2 is a graph of the reaction kinetics.

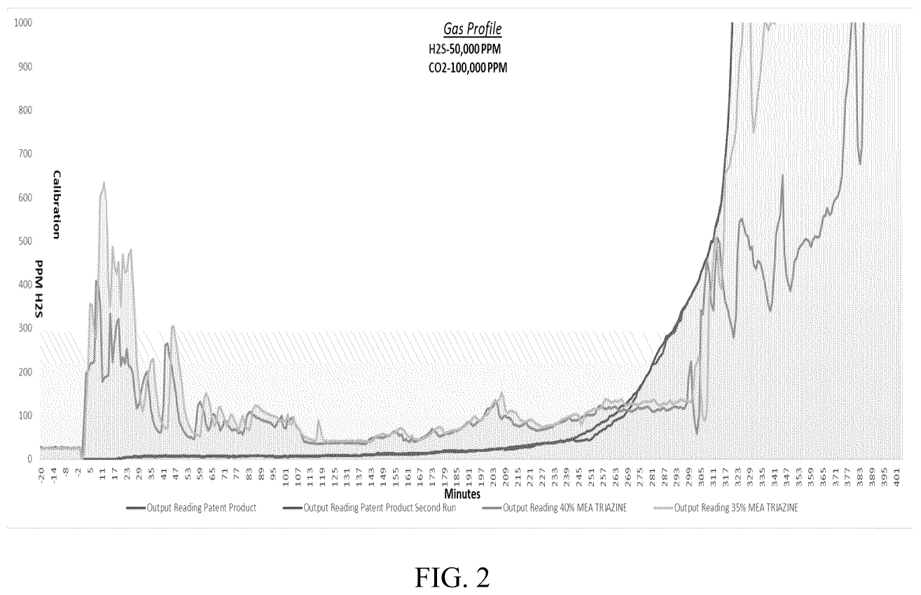

FIG. 3 is an annotated graph of the reaction kinetics.

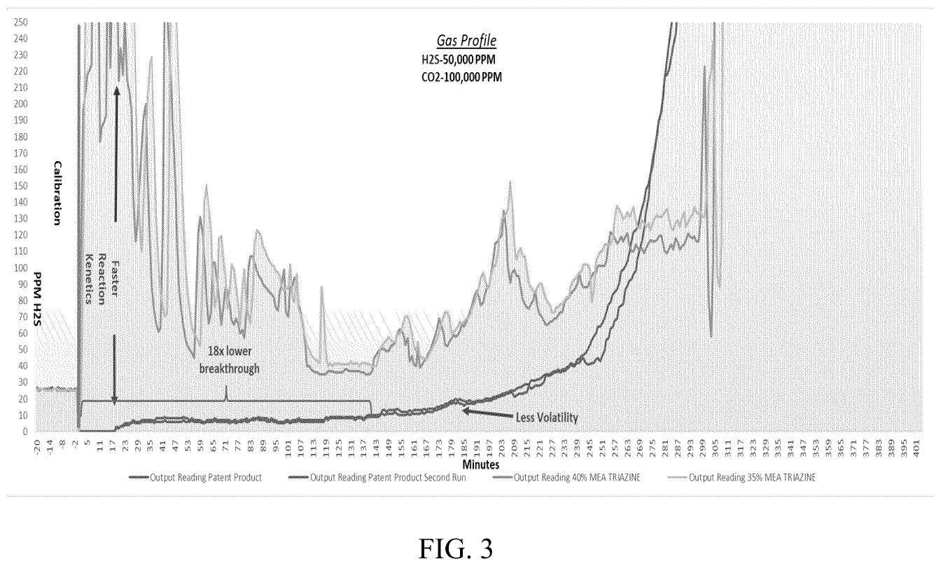

FIG. 4 is a graph of a higher temperature profile reaction kinetics.

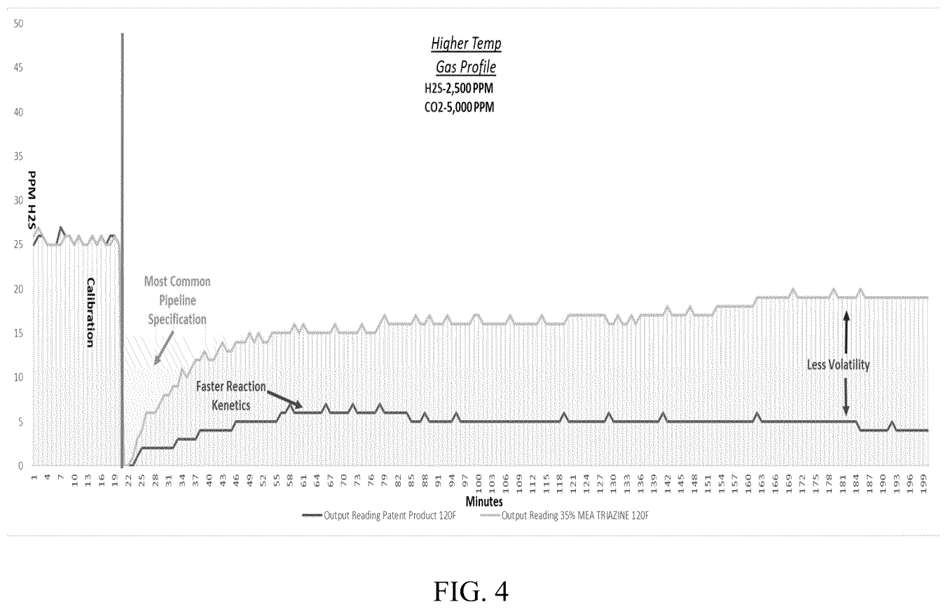

### DETAILED DESCRIPTION OF THE INVENTION

All patents, published patent applications and articles referenced herein are hereby incorporated by reference in their entirety.

### Selected Definitions

As used herein, the following terms have the meanings set forth below unless otherwise stated or clear from the context of their use.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, 1.9, 1.13, 1.135, and so forth. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduces” means a negative alteration of at least 0.001%, 0.01%, 0.1%, 1%, 5%, 10%, 25%, 50%, 75%, or 100%, and “increases” means a positive alteration of at least means a negative alteration of at least 0.001%, 0.01%, 0.1%, 1%, 5%, 10%, 25%, 50%, 75%, or 100%.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates embodiments that “consist” or “consist essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood to be within 10%, 9%, 8%, 7%, 6%, 5%, 4%, 3%, 2%, 1%, 0.5%, 0.1%, 0.05%, 0.01%, 0.001% or 0.0001% of the stated value.

The recitation of a listing of chemical groups in any definition of a variable herein includes definitions of that variable as any single group or combination of listed groups.

The recitation of an embodiment for a variable or aspect herein includes that embodiment as any single embodiment or in combination with any other embodiments or portions thereof.

All parts, percentages and ratios are on an anhydrous basis unless otherwise stated or clear from the context.

As used herein, “applying” a composition or product refers to contacting it with a target or site such that the composition or product can have an effect on that target or site.

As used herein, a “hydrocarbon stream” is a liquid or, preferably, gaseous stream containing a hydrocarbon and may be an industrial or refining stream or a fossil fuel stream, e.g., from a well bore.

As used herein, the term “sulfhydryl” is used in a manner inconsistent with its common meaning in that it is used to include any compounds or chemical species comprising one or more sulfur atoms or ions, including but not limited to hydrogen sulfide, mercaptans, polysulfides, or combinations thereof. The sulfhydryl compounds are preferably represented by the formula R—S—H wherein R is hydrogen or alkyl of 1 to 6 carbon atoms. Furthermore, a sulfhydryl has a bisulfide anion with the formula HS⁻. The term “triazine” as used herein refers to substituted and unsubstituted hexahydrotriazine.

As used herein, a “dielectric component” is a material that has the ability to store electrostatic charges and release electrostatic charges. The charges can be from electrons, ions, molecular dipoles and the like.

As used herein, a “water-dispersible dielectric material” is a material that is itself water soluble or dispersible, or is in combination with another material (dispersing aid) that enables the dielectric material to be suspended in aqueous solution. Dispersing aids include, but are not limited to, sequestering agents, surfactants, especially non-ionic surfactants, and water-soluble polymer or copolymer which include the dielectric material as part of the backbone or encases the dielectric material. The term “dispersible” means that the material is dissolved or is capable of being suspended without agitation.

As used herein, a “surfactant” is a surface active agent having two functional groups, namely a hydrophilic (water-soluble) or polar group and a hydrophobic (oil-soluble) or non-polar group. The hydrophobic group is usually a long hydrocarbon chain (e.g., C8-C18), which may or may not be branched, while the hydrophilic group can be formed by moieties such as, for example, carboxylates, sulfates, sulfonates (anionic), alcohols, polyoxyethylenated chains (nonionic) and quaternary ammonium salts (cationic).

### Sulfur Scavenger Compositions

The subject invention provides compositions for scavenging sulfhydryl moieties and increasing the up-take of sulfhydryl moieties from hydrocarbon streams. In certain preferred embodiments, the compositions comprise an amine-based sulfur scavenger, water and a water dispersible, metal-containing, dielectric component. The water may comprise fresh water, salt water (e.g., water containing one or more salts dissolved therein), brine (e.g., saturated salt water), seawater, or any combination thereof.

In some embodiments, the compositions further comprise a hydrocarbyl alcohol having a terminal hydroxy group and about 6 to 24 carbons, at least one of which is a tertiary carbon.

In certain embodiments, the subject invention also pertains to an additive composition to be admixed with an aqueous, amine-based sulfur scavenger, which additive composition comprises a water-dispersible, metal-containing, dielectric component. In some embodiments, the additive composition can further comprise a hydrocarbyl alcohol comprising a terminal hydroxy group and about 6 to 24 carbons, at least one of which is a tertiary carbon. The use of the additive may, in some embodiments, increase the reaction rate of the amine-based sulfur scavenger with the sulfhydryl. In other embodiments, the additive may also react with the sulfhydryl to form nonhazardous and/or noncorrosive products.

The sulfur scavenger according to the subject invention can be any suitable amine-containing scavenger containing at least one primary, secondary or tertiary amine. In certain preferred embodiments, the scavengers are triazines. A number of the triazines useful in the compositions of this invention are commercially available. Commercial triazines often contain components such as water or unreacted amine. Typically, triazines are formed by reacting amines with an aldehyde, especially formaldehyde as is well known in the art. See, for instance U.S. Pat. No. 4,266,054. MMA triazine (hexahydro-1,3,5-tris(methyl) triazine and especially MEA triazine (1,3,5-(tris-hydroxyethyl) triazine) are preferred due to their reactivity with sulfhydryl moieties, commercial availability and relatively low cost. Examples of other triazines include MOPA triazine (1,3,5 tris-(3-methoxypropyl)-hexatriazine); 1,3,5 (tris-methoxyethyl) hexahydrotriazine; 1,3,5 (tris-methoxybutyl) hexahyrdotriazine; 1,3,5 (tris-ethyl) hexahydrotriazine and 1,3,5 (tris-propyl) hexahydrotriazine. The triazines can include compounds where each R group is the same or different. The preferred triazines have some water solubility. As the ring nitrogen atoms are replaced with sulfur atoms the triazines become less water soluble and may become substantially insoluble in water. Examples of other amines include, but are not limited to, poly(ethylene imine), diethyl amine, triethyl amine, monoethanol amine, diethanol amine, and methyl amine.

In certain embodiments, the water-dispersible, metal-containing, dielectric component according to the subject invention contains one or more metallic elements, which can be present as the metal or in a compound bonded to other atoms. In some embodiments, the dielectric component is provided in an effective amount to increase the up-take of the sulfur scavenger, all other conditions being substantially the same, and is frequently in a mass ratio (on an anhydrous basis) to sulfur scavenger between about, e.g., 0.001:1000 to 75:1000, 0.01:1000 to 50:1000, 0.03:1000 to 30:1000, 0.05:1000 to 20:1000, or 0.1 to 15:1000.

Examples of metallic atoms include, but are not limited to, magnesium, calcium, barium, titanium, zirconium, vanadium, niobium, tantalum, chromium, molybdenum, tungsten, manganese, iron, cobalt, nickel, copper, zinc, aluminum, gallium, silicon, germanium, selenium, tin, lead and bismuth. These metals can be in the form of oxides, carbides, carbonates, nitrides, nitrates, sulfides, sulfates or borates or in multi-metallic atom compounds such as aluminates, molybdates, titanates, tantalates, silicates, niobates, zirconates, and the like, and can be in amorphous or structured, including crystalline structures, such as ceramics, clays, crystals, glasses and the like.

In some embodiments, the dielectric component preferably has a dielectric constant of a least about, e.g., 2.0 to 2.5, preferably between about 2.0 to 200, 2.25 to 150, 2.5 to 100, 2.75 to 75, or 3.0 to 50. Dielectric components can be, for example, nanoparticles sufficiently small to be dispersed in water. In some embodiments, the metallic atoms can be present within a polymeric structure, which polymer is water soluble or otherwise dispersible in or in association with a hydrophilic surfactant or hydrophilic chelating agent, or within a polymer matrix that is water soluble or otherwise dispersible.

A commonly available polymeric structure containing metal atoms is poly(methylsiloxane)-containing homopolymers and copolymers, especially with ethylene oxide, that contain dimethysiloxane. The water solubility or dispersibility of polymers containing metallic atoms can be enhanced through copolymerization (random or block) with monomers providing hydrophilic polymers such as polyethylene glycol, polyvinyl acetate and polyvinyl alcohol. In some embodiments, these polymers and copolymers have a weight average molecular weight between about, e.g., 400 and 150,000, 450 and 125,000, 500 and 100,000, 550 and 80,000, 600 and 75,000, 650 and 65,000 or 700 and 50,000.

Where the metallic atoms are dispersed using surfactants, the surfactants are preferably non-ionic. Poly(alkylene oxide)-containing surfactants are readily available and have relatively low toxicity. Other non-ionic surfactants include, but are not limited to, polysorbates, polyglycerols, polyglycosides, stearates and the like.

Where the metallic atoms are dispersed using chelating agents, the chelating agents are preferably hydrophilic. Chelating agents according to the subject invention can include, but are not limited to, oxalic acid, succinic acid, citric acid, phthalic acid, ethylenediamine tetraacetic acid, diethylenetriamine pentaacetic acid, imidodiphosphoric acid, ethylamino diphosphonic acid, ethylenediamine tetra(methylene phosphonic acid), and diethylenetriamine penta(methylene phosphonic acid).

Polymer matrices that can be used to contain metallic atoms include, but are not limited to, hydrogels and anisotropic polymeric structures, e.g., structures with dense skins and porous interiors. Polymer matrices can be composed of any suitable polymer. Examples of polymers include, but are not limited to, polyvinyl alcohol, polyethylene glycol, acrylate polymers and copolymers, polyvinylpyrrolidone and polysulfonates, which polymers may be crosslinked.

If desired, the scavenger composition, or additive composition, can include a hydrocarbyl alcohol having a terminal hydroxy group, and wherein the hydrocarbyl alcohol comprises about 6 to about 24 carbons, about 8 to 22 carbons, about 10 to 20 carbons, or about 12 to 18 carbons. In a preferred embodiment, at least one of the carbons is a tertiary carbon. In a further preferred embodiment, the tertiary carbon has a hydroxy ethyl substituent and at least 5 of the carbons have only hydrogen substituents. The alcohol preferably has a solubility in water at 25° C. of less than about 100, less than about 50, less than about 40, less than about 30, or preferably less than about 20, grams per liter.

Examples of alcohols include, but are not limited to, 2-methylpentan(1)ol, 4-methylcyclohexanol, 3-propylcylohexanol, 3-ethylpentanol, 2-ethylhexanol, 4-ethylhexanol, phenol, cyclohexanol, 2-isopropylphenol, 4-isobutylphenol, 4-isopropylphenol, 2-methyloctanol, 2-ethyloctanol, 2-propyl-1-butanol, and 4-(2,4-dimethylheptan-3-yl) phenol.

In certain embodiments, the hydrocarbyl alcohol is provided in a mass ratio to the scavenger of between about, e.g., 5:1000 to 500:1000, 8:1000 to 450:1000, 10:1000 to 400:1000, 15:1000 to 350:1000, 25:1000 to 300:1000, 35:1000 to 250:1000, 50:1000 to 200:1000, or 75:1000 to 150:1000. In embodiments wherein the dielectric component is provided as an additive to be later admixed with a sulfur scavenger, the mass ratio (on an anhydrous basis) of dielectric component to hydrocarbyl alcohol in the additive composition is preferably between about, e.g., 0.5:100 to 50:100, 0.75:100 to 45:100, 1:100 to 40:100, 1.25:100 to 35:100, or 1.5:100 to 30:100. The additive composition can be added to the aqueous, amine-based sulfur scavenger in an amount sufficient to enhance the up-take of sulfhydryl moiety by the scavenger.

The compositions and additives according to the subject invention can include other components useful in sulfur scavenger composition.

In some embodiments, the additional additives include a carrier fluid, including aqueous fluids, non-aqueous fluids, and any combinations thereof. Suitable aqueous fluids may comprise water from any source. Such aqueous fluids may comprise fresh water, salt water (e.g., water containing one or more salts dissolved therein), brine (e.g., saturated salt water), seawater, or any combination thereof.

In most embodiments of the present disclosure, the aqueous fluids comprise one or more ionic species, such as those formed by salts dissolved in water. For example, seawater and/or produced water may comprise a variety of divalent cationic species dissolved therein.

In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate.

Examples of non-aqueous fluids that may be suitable for use in the methods and systems of the present disclosure include, but are not limited to oils, hydrocarbons, organic liquids, and the like. In certain embodiments, the fracturing fluids may comprise a mixture of one or more fluids and/or gases, including but not limited to emulsions, foams, and the like.

Further examples of additional additives include, but are not limited to, salts, surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents (e.g., ethylene glycol), polyhydroxylated hydrocarbons (which comprise, e.g., 2 to about 10 carbons, preferably 2 to about 6 carbons, and a hydroxy terminated poly(alkylene oxide), wherein the alkylene is from 2 to about 6 carbons, often having weight average molecular weights from about, e.g., 300 to 20,000, 350 to 15,000, or 400 to 10,000), an organic acid or salt thereof having at least one amino moiety substituted with two carboxyl or two phosphonyl moieties, and the like.

Specific non-limiting examples of corrosion inhibitors include acetylenic alcohols, such as propargyl alcohol organic amines; dimer/trimer acids derived from tall oil or other bases; quaternary amines derived from coconut, canola, tallow, tall oil or other bases; fatty alcohols; derivatized quinolines; alkyl pyridines; and oxyalkylated resin amines.

Anti-foam agents can include, for example, natural or mineral oils, silicone-based agents and/or polydimethylsiloxane (PDMS).

Scale inhibitors can include, for example, phosphonates, polyacrylates, polyphosphates, phosphate esters, chelating agents, polycarboxylic acids, hexametaphosphate and/or tripolyphosphate.

Alternatively, any additives used can be admixed with the sulfur scavenger. A person skilled in the art, with the benefit of this disclosure, will recognize the types of additives that may be included in the fluids of the present disclosure for a particular application.

### Methods

In certain embodiments, the subject invention provides methods for scavenging sulfhydryl compounds from hydrocarbon streams.

In certain embodiments, the sulfur scavenging composition and/or additives of the subject invention are injected into at least a portion of a subterranean formation, conduit, or container wherein a sulfhydryl compound is present. In certain embodiments, the compositions and/or additives react with the sulfhydryl to form nonhazardous and/or noncorrosive products.

The subject methods can be used to directly reduce sulfhydryl content in wells and crude oil and gas and the environments in which oil and gas are produced. The methods can further be used to reduce the “sourness” of crude oil and gas, reduce the conversion of sweet oil and gas to sour oil and gas, increase the conversion of sour oil and gas to sweeter oil and gas, and/or preserve the sweetness of oil and gas.

In certain embodiments, the methods can also be used for reducing and/or eliminating corrosion of equipment and structures used for crude oil and natural gas production through the reduction in acids and sulfhydryl concentration.

In accordance with certain embodiments of the processes of this invention, the scavenger composition is contacted with the hydrocarbon stream containing sulfhydryl moieties, especially hydrogen sulfide. In some embodiments, the method comprises applying an additive composition according to the subject invention to the hydrocarbon stream, either concurrently with, i.e., admixed, an amine-based sulfur scavenger or immediately before or after application of an amine-based sulfur scavenger.

The contacting can be affected in any convenient manner such as, for example, by injection of the scavenger composition into a process of transport line; passing the hydrocarbon stream such as a natural gas stream through a stirred or non-stirred vessel that contains the scavenger composition; and/or spraying or otherwise introducing the scavenger composition for contact with the hydrocarbon stream.

In some instances, the scavenger composition can be introduced into a well hole. The hydrocarbon stream may contain other components depending upon source. Especially for gas streams, nitrogen, carbon dioxide and water are often present an advantage of the compositions of this invention that the compositions are sufficiently robust to tolerate presence of other components in the hydrocarbon stream while still scavenging sulfhydryl moieties and retarding or avoiding the formation of solids. The hydrocarbon streams to be treated in accordance with this invention may contain up to, e.g., 5 or more volume percent, often between about, e.g., 10 and 1000, 9 and 900, 8 and 800, 7 and 700, 6 and 600 or 5 and 500 parts per million by volume, sulfhydryl moiety.

In certain embodiments, the duration of contact between the hydrocarbon stream and the scavenger composition in the scrubber is that which is sufficient to provide a treated hydrocarbon stream substantially devoid of hydrogen sulfide, preferably, e.g., less than about 5, less than about 1, less than about 0.1, and most preferably less than about 0.01, parts per million by volume of hydrogen sulfide. In most operations, the scavenger composition is used until the undesired breakthrough of hydrogen sulfide occurs in the treated hydrocarbon stream.

The temperature of the contacting can vary over a wide range and will often be determined by the temperature of the environment and the incoming hydrocarbon stream to be treated. In certain embodiments, the temperature is generally in the range of about, e.g., −10° C. to 150° C., about 0° C. to 125° C., or about 10° C. to 100° C.

In certain embodiments, the method of the subject invention includes introduction of a treatment fluid into a subterranean formation and/or a well bore that penetrates a subterranean formation. Treatment fluids can be used in a variety of subterranean treatment operations. As used herein, the terms “treat,” “treatment,” “treating.” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, and the like.

In certain embodiments, sulfur scavenging compositions and/or additives of the subject invention may be introduced into a subterranean formation, a well bore penetrating a subterranean formation, tubing (e.g., pipeline), and/or a container using any method or equipment known in the art. Introduction of the sulfur scavenging compositions and/or additives may include delivery via any of a tube, umbilical, pump, gravity, and combinations thereof. Additives, treatment fluids, or related compounds of the subject invention may, in various embodiments, be delivered downhole (e.g., into the well bore) or into top-side flowlines/pipelines or surface treating equipment.

For example, in certain embodiments, the subject compositions and/or additives may be applied to a subterranean formation and/or well bore using batch treatments, squeeze treatments, continuous treatments, and/or combinations thereof. In certain embodiments, a batch treatment may be performed in a subterranean formation by stopping production from the well and pumping a specific amount or quantity of the compositions and/or additives, which may be performed at one or more points in time during the life of a well. In other embodiments, a squeeze treatment may be performed by dissolving the compositions and/or additives in a suitable solvent at a suitable concentration and squeezing that solvent carrying the compositions and/or additives downhole into the formation, allowing production out of the formation to bring the compositions and/or additives to the desired location. In certain embodiments, the sulfhydryl is present in a gaseous phase and the compositions and/or additives may be injected as a mist. In other embodiments, the sulfhydryl is present in a gaseous phase and the subject compositions and/or additives may be injected as a liquid, such that the gaseous phase bubbles through them in a tower.

In still other embodiments, treatment fluids and/or additives of the present disclosure may be injected into a portion of a subterranean formation using an annular space or capillary injection system to continuously introduce the compositions and/or additives into the formation. Other means and/or equipment that may be used to continuously inject the compositions and/or additives into a well bore include, but are not limited to slip-stream systems, annulus drip systems, cap strings, umbilical strings, gas lift systems, continuous metering systems, subsurface hydraulic systems, bypass feeders, and the like.

In certain embodiments, continuous injection equipment at a well site may be controlled from a remote location and/or may be partially or completely automated. In certain embodiments, a treatment fluid comprising a composition and/or additive of the subject invention may be circulated in the well bore using the same types of pumping systems and equipment at the surface that are used to introduce treatment fluids or additives into a well bore penetrating at least a portion of the subterranean formation. In certain embodiments, the composition and/or additive could be dried and formed into a solid for delivery into rat holes, tanks, and/or a well bore.

In certain embodiments, the subject compositions and/or additives may be added to a pipeline where one or more fluids enter the pipeline at one or more other locations along the length of the pipeline. In these embodiments, the subject compositions and/or additives may be added in batches or injected substantially continuously while the pipeline is being used.

In some embodiments, the components of the compositions and/or additives are not mixed until they are injected into the subterranean formation, conduit, or container. In certain embodiments, the compositions and/or additives are mixed shortly before they are injected. In other embodiments, a spacer is used to keep the components of the compositions and/or additives from mixing until they reach a particular portion of a subterranean formation, conduit, or container.

The sulfur scavenging compositions and/or additives of the subject invention can be used in a variety of applications. These include downhole applications (e.g., drilling, fracturing, completions, oil production), use in conduits, containers, and/or other portions of refining applications, gas separation towers/applications, pipeline treatments, water disposal and/or treatments, and sewage disposal and/or treatments.

The present disclosure in some embodiments provides methods for using the additives, treatment fluids, and related compounds to carry out a variety of subterranean treatments, including but not limited to, hydraulic fracturing treatments, acidizing treatments, and drilling operations.

### Example 1

In a specific embodiment, the composition comprises 2 ethyl hexanol; glycerine, EDTA, and poly dimethyl siloxane, together with MEA triazine or other amine-based sulfur scavenger. The concentrations of these ingredients can be, for example:
2 ethyl hexanol at 0.3% to 1.0%. 0.4% to 0.75%, 0.5% to 0.6%, or 0.56%, or any ranges therebetween;
glycerine at 3% to 9%, 4% to 8%, 5% to 7%, or 6%, or any ranges therebetween;
EDTA at 0.4% to 1.0%, 0.5% to 0.9%, 0.6% to 0.75%, or 0.625%, or any ranges therebetween;
Poly dimethyl siloxane at 0.01% to 0.07%, 0.02% to 0.06%, 0.03% to 0,05%, or 0.04%, or any range therebetween.

The amine-based sulfur scavenger may be, for example, 15% to 40% MEA triazine, such as 25% MEA triazine.

The balance of the composition being water.

The subject invention further provides additives with the above ingredients (and/or other ingredients of the same category/function) that, when added to the amine-based sulfur scavenger, produce the composition set forth above.

### Example 2

A composition of the subject invention (Composition A) was compared to a well-known and previously-studied amine-based H₂S scavenger: MEA triazine (1,3,5-(tris-hydroxyethyl) triazine).

There are three key performance characteristics that establish the proficiency of an H₂S scavenger in removing sulfhydryl moieties from hydrocarbon streams. The first performance parameter is stochiometric capacity to absorb sulfur, also known as the total sulfur uptake capacity. The second parameter is reaction kinetics, which is the speed at which the H₂S scavenger's uptake capacity can absorb, or react-out, sulfhydryl moieties from the hydrocarbon stream. The third parameter is the H₂S scavenger's propensity to prevent solids deposition of the scavengers by-products, or providing a higher tolerance towards the mitigation of such deposition.

These three performance parameters can be expressed as the equation: Ax (Total Uptake Capacity)+Bx (Reaction Kinetics)+Cx (Solids Mitigation)=Dx (Increased Scavenger Performance).

Composition A (percentages are by volume):
0.56% 2 Ethyl Hexanol;
6.00% glycerine;
0.625% EDTA;
0.04% poly dimethyl siloxane;
25% MEA Triazine; and
Balance is distilled water.

MEA triazine was selected to compare with Composition A because its performance attributes are well understood, and it is the most widely applied technology across all industry platforms to remove sulfhydryl moieties from hydrocarbon streams.

The sulfhydryl moieties used for this evaluation were obtained from Air Gas and contained a certified gas composition containing 50,000 ppm hydrogen sulfide, and 100,000 ppm carbon dioxide, with the remaining composition being nitrogen. Carbon dioxide was selected because most hydrocarbon streams contain various concentrations of this gas with sulfhydryl moieties, and certain H₂S scavenger technologies performance can be adversely affected by the presence of carbon dioxide.

An air pomp was used to dilute the gas composition stream to demonstrate performance characteristics associated with reaction kinetics from various sulfhydryl moieties gas stream concentrations.

All performance test runs comparing Composition A to MEA triazine were run under the same set of conditions using the same equipment configuration.

Flow rates were set at a static 0.65 standard cubic feet per hour (SCFH) or 0.3 liters per minute. 50 milliliters of chemistry is used to establish a small liquid contact bed within a miniature contact tower containing a gas sparge. The contact tower has a total volumetric capacity of 250 milliliters. The gas was sparged through the contact fluid (scavenger medium) and directly exited via a small tube to an AMI model 3000rs autonomous H₂S analyzer that pulls breakthrough H₂S concentrations ˜minute. Calibrated gas of ˜25ppm H₂S was passed through the detector before each test run to verify sensor accuracy before performance evaluations.

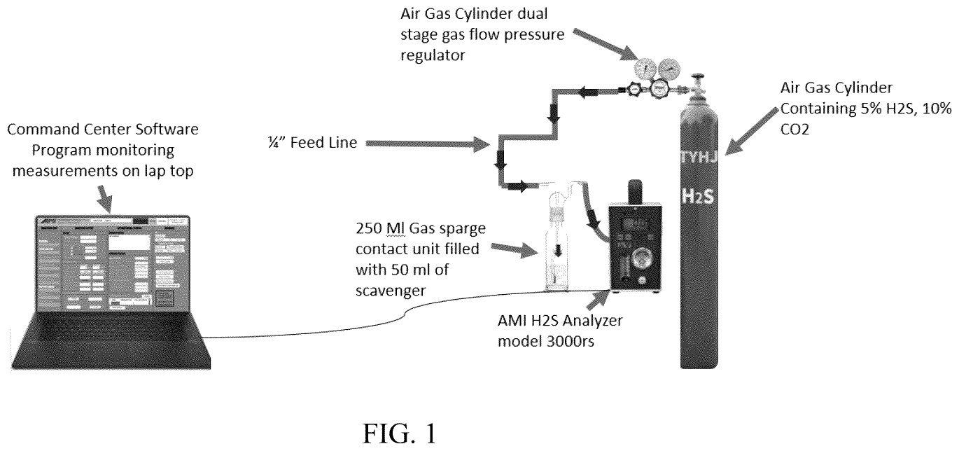

FIG. 1 is a depiction of the test setup used to evaluate sulfur loading and reaction kinetics.

### Total Sulfur Uptake Capacity (Ax)

Each test run began with a calibration check proceeding the test. Once the H₂S breakthrough exceeded the sensor range, H₂S (lead acetate) tubes were manually pulled to verify that the H₂S scavenger was no longer actively scavenging. The subsequent spent scavenger fluid was measured before and after for density changes. Sulfur content was measured with both FT-IR (Fourier Transform InfraRed) spectrophotometry and XRF (X-Ray Fluoresce) to determine the amount of absorbed sulfur. The run times ranged from 8-12 hours.

Table 1 provides a summary of the total sulfur contents. The results demonstrate that even though Composition A has a much lower amine concentration, the capacity performed similarly to MEA triazine.

TABLE 1

| | | | | Measured | Calculated | Uptake |
|---|---|---|---|---|---|---|
| | | Density of | | total uptake | Uptake before | Improvement |
| % | | Unreacted | | via FTIR and | Sensor over- | based on |
| Active | | Chemistry | Measured | XRF (sulfur | range (sulfur | measured % |
| Amine | Product Name | (lbs/gal) | % Sulfur | lbs/gal) | lbs/gal) | sulfur |
| 25% | Composition A used with | 8.90 | 13.98% | 1.24 | 1.05 | 36.5% |
| | MEA-Triazine | | | | | |
| 40% | 40% 1,3,5 MEA-Triazine | 9.01 | 14.03% | 1.26 | 1.23 | |
| 35% | 35% 1,3,5 MEA-Triazine | 8.92 | 12.29% | 1.10 | 1.09 | |

| | | |
|---|---|---|
| 25% | 1,3,5 MEA-Triazine Calculated | 0.79 |

### Reaction Kinetics (Bx)

Each test run began with a calibration check proceeding the test. The test runs reflect two types of test stress conditions. The first test run was performed under ultra-high H₂S saturation conditions (5% or 50,000 ppm). The second set of test runs were designed to demonstrate the effects of higher gas temperatures by pre-heating the liquid medium to 120 F and passing the sulfhydryl moieties through the liquid contact scavenger bed that was heated to 120 F throughout the duration of the test.

This test was designed to differentiate the effects of either the volatility of the scavenger and/or by creating a heated liquid interphase, the reduced apparent viscosity would reduce the contact time of the gas within the bed due to lower interfacial tension between two substrates (in this case liquid to gas). All test runs were run at the aforementioned 0.65 SCFH or 0.3 liters per minute.

Of important note to the evaluation of reaction kinetics is that most pipeline shipping specifications from midstream companies require oil and gas operators/producers to maintain a hydrogen sulfide concentration below 10 ppm.

On the high H₂S profile containing 50.000 ppm hydrogen sulfide, the Composition A maintained an H₂S breakthrough PPM below 10 ppm for an average of 141 minutes with an average H₂S breakthrough of just 5.86 ppm.

35% MEA triazine eclipsed the 10 ppm threshold in as little as 2 minutes with an average H₂S breakthrough of 150 ppm in the same respective time frame (141 minutes).

40% MEA triazine eclipsed the 10 ppm threshold in as little as 2 minutes with an average H₂S breakthrough of 109 ppm in the same respective time frame (141 minutes).

This demonstrates a minimum factor of 18× lower H₂S breakthrough concentration for Composition A. This reduces the contact time needed and significantly widens the application options.

On the lower H₂S profile containing 2,500 ppm hydrogen sulfide with simulated higher thermal profile temperatures, Composition A maintained an H₂S breakthrough PPM below 10 ppm for the duration of the 180-minute test run with an average H₂S breakthrough of just 4.79 ppm. This demonstrates the resilience of the technology under higher thermally simulated conditions.

35% MEA triazine eclipsed the 10 ppm threshold in as little as 14 minutes with an average H₂S breakthrough of 15.75 ppm in the same respective time frame (180 minutes).

This demonstrates a minimum factor of 3× lower HS breakthrough ppm concentration for Composition A with a 166 minute longer runtime below pipeline specifications.

### Solids Mitigation (Cx)

One common drawback to MEA triazine is the propensity to form solids. Those solids can best be described as amorphous di-thiazine, also known as poly sulfides.

Advantageously, the compositions of the current invention reduce solids formation. The multimolecular formation of clusters exhibits a unique interchange at the interface of the molecules, wherein an exchange takes place with the sulfhydryl moieties that inhibits the formation of longer chain polysulfides.

Another unique aspect of the subject invention, is that the formula can be adjusted to maintain the clusters indefinitely or designed to phase separate once the scavenger is spent. This allows for the cluster to be formulated such that the cluster breaks rapidly once the scavenger is spent, separating into two distinct phases. This allows for a liquid bottom phase containing the sulfur to be recovered, should that attribute be desired for recycling and/or repurposing of sulfur rich fluids.

### Increased Scavenger Performance Summary (Dx)

A high performing H₂S scavenger can be represented by the following equation: Ax (Total Uptake Capacity)+Bx (Reaction Kinetics)+Cx (Solids Mitigation)=Dx (Increased Scavenger Performance). With 36.5% higher total uptake capacity then the amine's designed capacity would traditionally allow, reaction kinetics ranging from 3× to 18× less breakthrough H₂S ppm, the tested embodiment forming clusters that prevent solids from precipitate and having the ability to specifically formulate for the allowed ease of recovering sulfur for recycling purposes, the compositions and methods of the subject invention have obtained all three key performance criteria for exhibiting the advantages of this technology.

I claim:

1. A sulfhydryl scavenger composition comprising an amine-based sulfur scavenger; water; and a water-dispersible, metal-containing, dielectric component.

2. The composition of claim 1, wherein the dielectric component is present in the composition in an amount sufficient to increase sulfur up-take of the composition.

3. The composition of claim 2, having a mass ratio, on an anhydrous basis, of the dielectric component to the sulfur scavenger of between about 0.01:1000 to 50:1000.

4. The composition of claim 1, wherein the composition comprises a triazine as an amine-based sulfur scavenger.

5. The composition of claim 4, wherein the composition comprises, as an amine-based sulfur scavenger, at least one of MEA triazine (1,3,5-(tris-hydroxyethyl) triazine) and MMA triazine (hexahydro-1,3,5-tris(methyl) triazine.

6. The composition of claim 1, further comprising a hydrocarbyl alcohol having a terminal hydroxyl group.

7. The composition of claim 6, wherein the terminal hydroxyl group comprises 8 to 24 carbons, and wherein at least one of the 8 to 24 carbons is a tertiary carbon.

8. The composition of claim 6, which has a mass ratio of the hydrocarbyl alcohol to the scavenger of between about 10:1000 to 400:1000.

9. The composition of claim 1, comprising the following ingredients:
2 ethyl hexanol;
glycerine;
EDTA;
poly dimethyl siloxane; and
MEA triazine.

10. The composition of claim 9, comprising the following ingredients:
2 ethyl hexanol at 0.3% to 1.0%;
glycerine at 3% to 9%;
EDTA at 0,4% to 1.0%;
poly dimethyl siloxane at 0.01% to 0.07%; and
15% to 40% MEA triazine.

11. The composition of claim 10, comprising the following ingredients:
2 ethyl hexanol at 0.56%;
glycerine at 6%;
EDTA at 0.625%;
poly dimethyl siloxane at 0.04%; and
25% MEA triazine.

12. A process for reducing an amount of sulfhydryl moieties in a hydrocarbon stream, wherein said process comprises contacting, in the presence of water, said hydrocarbon stream with a sulfhydryl scavenger composition of claim 1.

13. An additive composition for improving performance of an amine-based sulfur scavenger in removing sulfhydryl moieties from a hydrocarbon stream, said additive composition comprising a dielectric component and a hydrocarbyl alcohol having a terminal hydroxy group.

14. The composition of claim 13, wherein the hydrocarbyl alcohol comprises 8 to 24 carbons, and wherein at least one of the 8 to 24 carbons is a tertiary carbon.

15. The composition of claim 13, which has a mass ratio of the dielectric component to the hydrocarbyl alcohol of between about 0.5:100 to 50:100.
